(19) United States
(12) Patent Application Publication
(10) Pub. No.: US 2018/0364938 A1
(43) Pub. Date: Dec. 20, 2018

(54) EXTENT-BASED DATA LOCATION TABLE MANAGEMENT

(71) Applicant: Burlywood, LLC, Longmont, CO (US)

(72) Inventors: Erik Habbinga, Fort Collins, CO (US); Tod Roland Earhart, Longmont, CO (US); Nathan Koch, Longmont, CO (US); David Christopher Pruett, Longmont, CO (US); John Slattery, Boulder, CO (US)

(21) Appl. No.: 16/008,249

(22) Filed: Jun. 14, 2018

Related U.S. Application Data
(60) Provisional application No. 62/519,274, filed on Jun. 14, 2017.

(51) Int. Cl. G06F 3/06; G06F 12/02

(52) U.S. Cl. CPC G06F 3/0644; G06F 3/0629; G06F 3/0671; G06F 3/061; G06F 12/0292

(57) ABSTRACT

A storage controller is provided. The storage controller includes a host interface, a media interface, and a processing system coupled with the host interface and the media interface. The processing system is configured to configured to maintain a translation table that relates logical addressing to physical blocks of the one or more storage media using at least an extents-based scheme in the translation table to relate the logical addressing to the physical blocks, wherein the extents-based scheme comprises a starting location combined with span length of a sequential portion of data stored on the one or more storage media, and the processing system also configured to handle storage operations of the storage drive in accordance with the translation table.

### RELATED APPLICATIONS

This application hereby claims the benefit of and priority to U.S. Provisional Patent Application Number 62/519,274, titled “EXTENT-BASED DATA LOCATION TABLE MANAGEMENT,” filed on Jun. 14, 2017 and which is hereby incorporated by reference in its entirety.

### TECHNICAL BACKGROUND

Data storage devices typically partition their storage media into a large number of physical data blocks, such as tracks on a disk drive. Physical data blocks are the smallest unit of storage readable or writable from the storage medium. Typically, data blocks each contain a large number of logical blocks. Logical blocks are the smallest unit of storage media accessible over a host interface and typically are 512 or 4096 bytes in size. Multiple logical blocks are combined to form physical data blocks. Each logical block has a logical block address, and each data block has a data block address.

When a host computer sends data to a data storage system for writing, the data storage device must map the logical block addresses into physical data block addresses for storage within the media. Traditionally, this mapping is done using a direct map of logical block addresses to data block addresses to locate physical data blocks on the storage medium. This approach handles all possible data traffic patterns at the cost of the size of the translation memory needed to hold the direct map. Translation memory can be any volatile or non-volatile memory needed to hold the data location information, such as DRAM (volatile) or NAND flash (non-volatile). The translation memory cost may limit the overall size of the storage device, as the direct map storage needs are proportional to the storage medium size.

### OVERVIEW

Traffic patterns describe the access patterns used to read or write data to a storage device. Sequential reads and writes access sequential physical data block address ranges. Random reads and writes access non-sequential physical data block address ranges in an unpredictable pattern.

Storage devices in environments that use mostly sequential data traffic patterns can track data block ranges in extents (the range of storage blocks with consecutive addresses, described by a start address and a block count) to reduce the translation memory needed to locate physical data blocks on the storage medium, allowing a larger storage medium size with the same translation memory footprint of a traditional storage device.

In an embodiment, a storage controller for a storage system is provided. The storage controller includes a host interface, a media interface, and a processing system coupled with the host interface and the media interface.

The processing system is configured to maintain a translation table that relates logical addressing to physical blocks of the one or more storage media using at least an extents-based scheme in the translation table to relate the logical addressing to the physical blocks, wherein the extents-based scheme comprises a starting location combined with span length of a sequential portion of data stored on the one or more storage media, and the processing system also configured to handle storage operations of the storage drive in accordance with the translation table.

In another embodiment, a method of operating a storage controller is provided. The method includes receiving data from a host system through a host interface, the data using logical addressing.

The method also includes maintaining a translation table that relates logical addressing to physical blocks of one or more storage media using at least an extents-based scheme in the translation table to relate the logical addressing to the physical blocks, wherein the extents-based scheme comprises a starting location combined with span length of a sequential portion of data stored on the one or more storage media, and storing the data in the physical blocks within the storage media through a media interface in accordance with the translation table.

In a further embodiment, a storage drive is provided. The storage drive includes a processing system configured to maintain a translation table that relates logical addressing to physical blocks of one or more storage media using at least an extents-based scheme in the translation table to relate the logical addressing to the physical blocks, wherein the extents-based scheme comprises a starting location combined with span length of a sequential portion of data stored on the one or more storage media. The processing system is also configured to handle storage operations of the storage drive in accordance with the translation table.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computer host and data storage system.

FIG. 2 illustrates an example prior art translation table.

FIG. 3 illustrates an example extents-based translation table.

FIG. 4 illustrates a method for operating a storage controller.

FIG. 5 illustrates an example storage controller.

### DETAILED DESCRIPTION

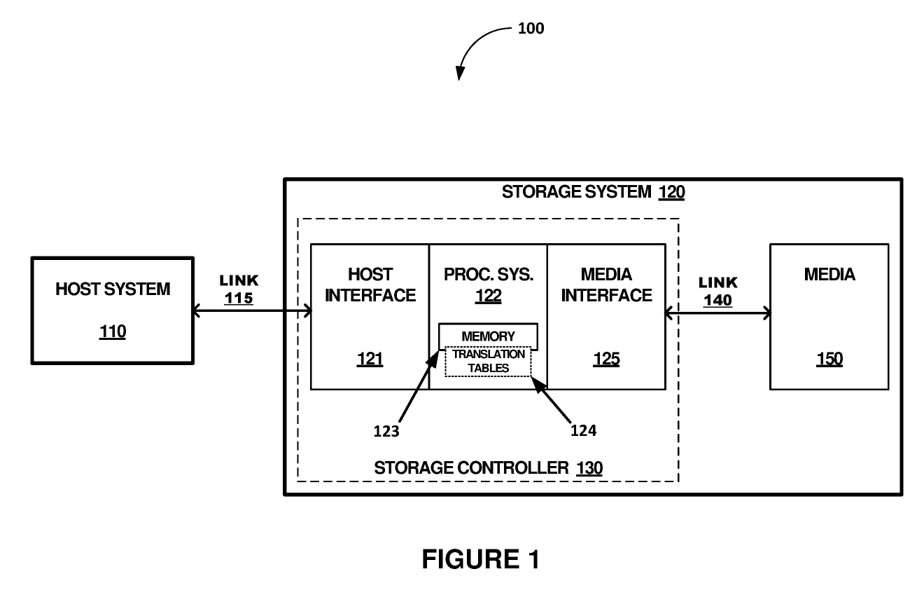

FIG. 1 illustrates one example configuration 100 of the enhanced storage systems, devices, and operations discussed herein. In FIG. 1, host system 110 is communicatively coupled to storage system 120 over communication link 115 and through host interface 121. Storage drive 120 includes processing system 122 that includes one or more translation tables 124 that can be stored in one or more memory devices 123, such as dynamic random-access memory (DRAM) or other working memory 123. The storage drive also includes a media interface subsystem 125, and storage media 150. The media interface subsystem 125 can include one or more Open NAND Flash Interface (ONFI) modules. The storage media 150 comprises one or more solid state storage media, such as flash media, among other media types.

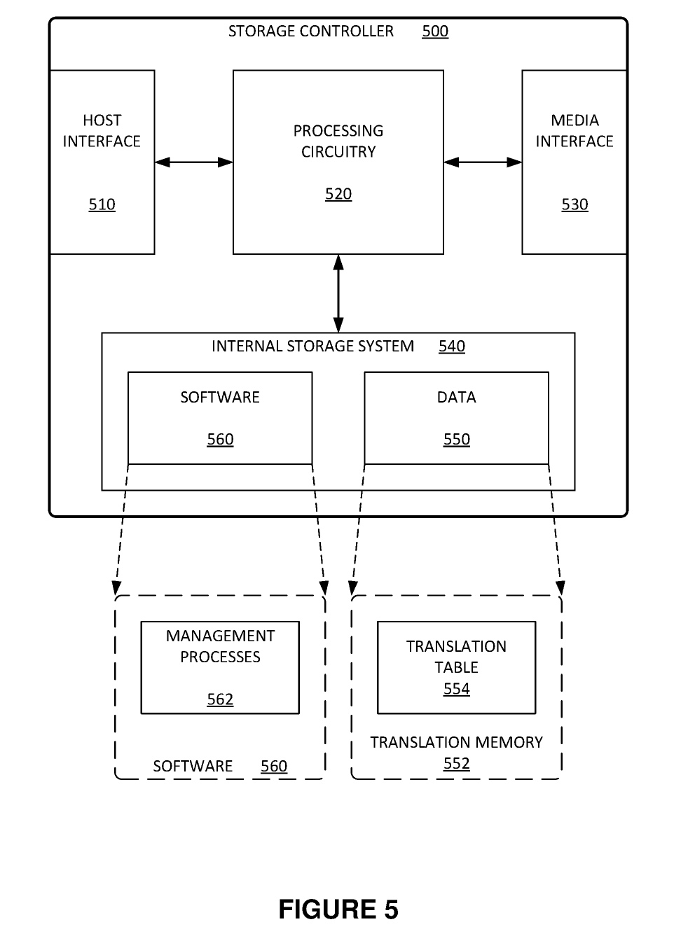

Host interface 121, processing system 122, and media interface subsystem 125 together comprise storage controller 130 configured to interface between host system 110 and storage media 150. This storage controller is illustrated in FIG. 5 and described in more detail below. Storage controller 130 may take any of a variety of configurations. In some examples, storage controller may be a Field Programmable Gate Array (FPGA) with software, software with a memory buffer, an Application Specific Integrated Circuit (ASIC) designed to be included in a single module with storage media 150 (such as storage system 120), a set of Hardware Description Language (HDL) commands, such as Verilog or System Verilog, used to create an ASIC, a separate module from storage media 150, or any of many other possible configurations.

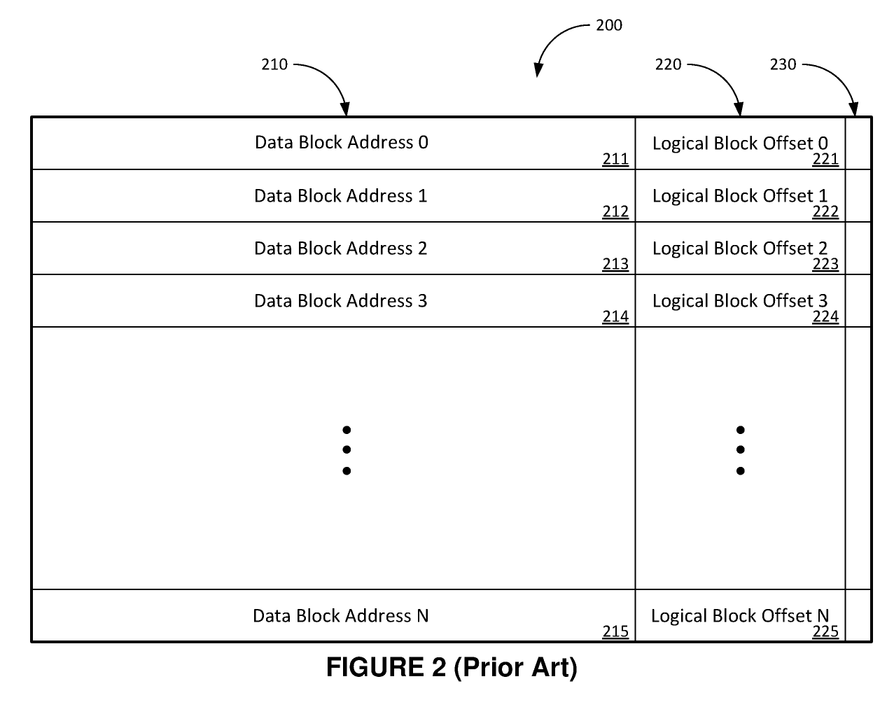

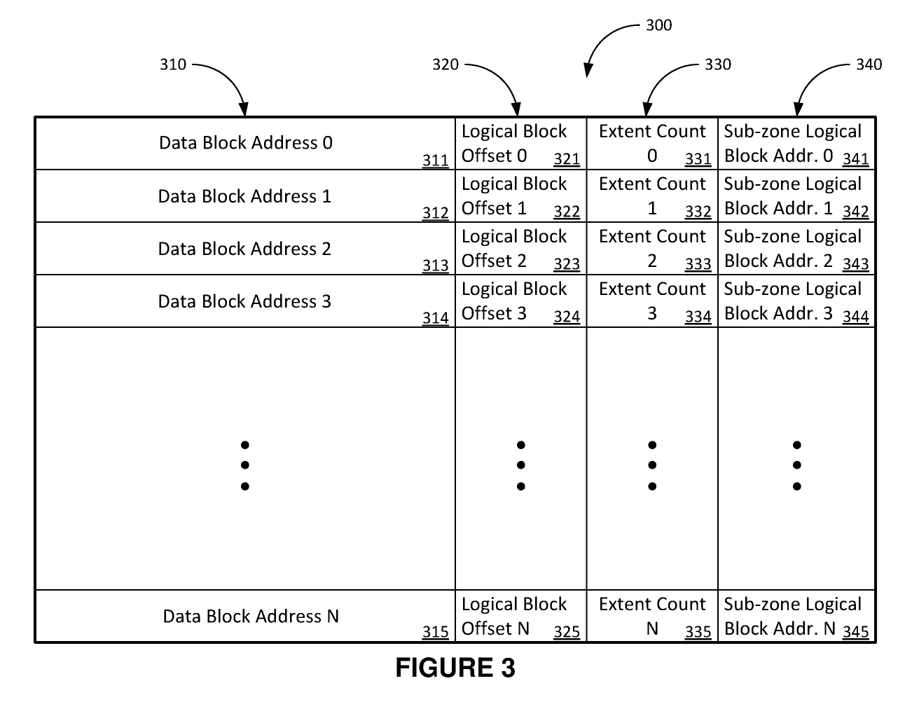

In operation, processing system 122 maintains translation table 124 that translates between logical storage blocks and physical storage blocks of the storage media 150. However, in the enhanced examples herein, an ‘extents’ based translation table 124 can be employed. This ‘extents’ based translation table 124 tracks storage address translations based in part on “start location” and “span length” indicators for storage locations. The start indicator relates to a starting location for a sequential portion of data written to the storage media, and the “length” indicator relates to how many storage blocks are spanned by that sequential portion of data. In conventional storage drives, a 1:1 relationship between logical-to-physical block mapping is maintained, such as that illustrated in FIG. 2 and described below, and consumes a large amount of working memory for a storage drive. In the enhanced examples herein, a denser mapping, such as that illustrated in FIG. 3 and described below, is achieved to reduce the amount of working memory needed for a given storage space. Moreover, storage media 150 can be ‘zoned’ into different portions with a first portion using the enhanced ‘extents’ based translation table features suited for sequential writes, and a second portion using the conventional 1:1 translation table suited for random writes.

In further examples, various triggering mechanisms can be employed to manage a zone using a conventional 1:1 translation table to an ‘extents’ based translation table 124. For example, triggering events may include when the conventional 1:1 translation table grows too large for the memory, when the conventional 1:1 translation table exceeds a threshold size, and the like.

Host system 110 communicates with storage system 120 through host interface 121 over communication link 115. Communication link 115 may use the Internet or other global communication networks. Each communication link may comprise one or more wireless links that can each further include Long Term Evolution (LTE), Global System for Mobile Communications (GSM), Code Division Multiple Access (CDMA), IEEE 802.11 WiFi, Bluetooth, Personal Area Networks (PANs), Wide Area Networks, (WANs), Local Area Networks (LANs), or Wireless Local Area Networks (WLANs), including combinations, variations, and improvements thereof. These communication links can carry any communication protocol suitable for wireless communications, such as Internet Protocol (IP) or Ethernet.

Additionally, communication links can include one or more wired portions which can comprise synchronous optical networking (SONET), hybrid fiber-coax (HFC), Time Division Multiplex (TDM), asynchronous transfer mode (ATM), circuit-switched, communication signaling, or some other communication signaling, including combinations, variations or improvements thereof. Communication links can each use metal, glass, optical, air, space, or some other material as the transport media. Communication links may each be a direct link, or may include intermediate networks, systems, or devices, and may include a logical network link transported over multiple physical links. Common storage links include SAS, SATA, NVMe, Ethernet, Fiber Channel, Infiniband, and the like.

Storage controller 130 communicates with storage media 150 over link 140. Link 140 may be any interface to a storage device or array. In one example, storage media 150 comprises NAND flash memory and link 140 may use the Open NAND Flash Interface (ONFI) command protocol, or the “Toggle” command protocol to communicate between storage controller 130 and storage media 150. Other embodiments may use other types of memory and other command protocols. Other common low level storage interfaces include DRAM memory bus, SRAM memory bus, and SPI.

Link 140 can also be a higher level storage interface such as SAS, SATA, PCIe, Ethernet, Fiber Channel, Infiniband, and the like. However—in these cases, storage controller 130 would reside in storage system 120 as it has its own controller.

As discussed above, a traditional storage device has a direct map between logical block address and physical data block location.

For a 1 tebibyte (TiB))(2⁴⁰) storage device with 128 kibibyte (KiB) (2¹⁷) data block size and 512-byte (B) (2⁹) logical block size, there are 8,388,608 (2⁴⁰/2¹⁷=2²³) data block addresses, 2,147,483,648 (2⁴⁰/2⁹=2³¹) logical block addresses (LBAs), and 256 (2¹⁷/2⁹=2⁸) possible offsets within a data block where a logical block can exist. Any logical block can live in any data block on logical block size offsets (i.e. 0-byte offset, 512-byte offset, . . . 130,560-byte offset).

It takes 31 bits of data to locate a logical block location with the data block address space:
23 bits to describe 8,388,608 data block addresses
8 bits to describe 256 logical block offsets within a data block
   Due to computer architecture constraints, 31 bits of data is most efficiently accessed as the next divisible-by-8 number of bits, which would be 32 bits, or 4 bytes.

FIG. 2 illustrates an example prior art translation table 200. In this prior art example, 23-bit wide column 210 contains data block addresses, including Data Block Address 0 211, Data Block Address 1 212, Data Block Address 2 213, Data Block Address 3 214, and Data Block Address N 215. 8-bit wide column 220 contains logical block offsets, including Logical Block Offset 0 221, Logical Block Offset 1 222, Logical Block Offset 2 223, Logical Block Offset 3 224, and Logical Block Offset N 225. 1-bit wide column 230 is included to pad the table out to be 32 bits wide.

A 1 TiB storage device direct map would require 4 (2²) bytes of storage for each logical block address to locate that logical block in the data block address space. A 1 TiB storage device has 2,147,483,648 (2³¹) logical block addresses, requiring 8,589,934,592 (2³¹*2²=2³³) bytes (8 gibibyte (GiB)) of storage to contain the direct map. A 2 TiB storage device would require 16 GiB of storage to contain the direct map. In a traditional SSD, translation is usually between a 4 k chunk of HBAs directly to a flash address that can be compacted into 4 bytes. The HBA itself does not need to be stored, as the array index can be calculated as “HBA modulo 4.” So, for flat map, 2 TiB/4 k*4=2 GiB of storage. Then the traditional SSDs can achieve larger capacities/less memory just by grouping HBAs into larger chunks, forcing a read/modify/write if data is written in smaller chunks. At current volatile memory (i.e. DRAM) size and cost values, the direct map approach becomes constrained by translation memory costs, limiting storage device size even though larger storage mediums are available.

A storage device in a mostly sequential traffic pattern environment can take advantage of the sequentially of the traffic to reduce data translation memory footprint. As data translation memory is used up, randomly written data on the storage medium can be re-written to re-sequentialize the data to free up data translation memory at the cost of write amplification.

Consider a storage device with 512 B (2⁹) logical blocks in an environment where most host interface write commands are in an efficient block (i.e. eBlock) size of 128 KiB (2¹⁷, or 2¹⁷/2⁹=2⁸=256 512 B logical blocks). Efficient blocks (eBlocks) are the ideal unit of storage to achieve the greatest efficiency of RAM and flash memory usage. These eBlocks are not necessarily written in sequential order (i.e. the eBlock containing LBAs 0-255 could be followed by an eBlock containing LBAs 512-767). Each eBlock can be described by an extent containing data block address, data block offset, and a logical block count. Applications running on a filesystem have a good chance of controlling write command size, but not data alignment with respect to the logical block address space. Thus, the eBlock extent also needs to track the logical block address from the write command

If the storage device logical block address space is divided into zones, and each zone contains a group of extents, the extent only needs to hold part of the logical block address. One part of the logical block address identifies the zone, and the remaining part of the logical block address can identify the extent. A 1 TiB (2⁴⁰) drive with 2,147,483,648 (2⁴⁰/2⁹=2³¹) 512 B (2⁹) logical blocks divided into 4 mebibyte (MiB) (2²²) zones requires the extent to track the 9 bit (2³¹/2²²=2⁹) sub-zone logical block address component.

For the example 1 TiB drive with 4 MiB zone size, an extent of 1 to 256 logical blocks is described in 48 bits (6 bytes):

23 bits to describe 8,388,608 data block addresses

8 bits to describe 256 logical block offsets within a data block

8 bits to describe an extent count of 1-256 logical blocks

9 bits to describe the sub-zone logical block address component

FIG. 3 illustrates an example extents-based translation table 300. In this example embodiment of the present invention, extents-based translation table 300 includes four columns of data: 23-bit wide column 310 contains data block addresses, 8-bit wide column 320 contains logical block offsets, 8-bit wide column contains extent counts of the logical blocks, and 9-bit wide column 340 contains sub-zone logical block addresses.

In this example, column 310 contains Data Block Address 0 311, Data Block Address 1 312, Data Block Address 2 313, Data Block Address 3 314, and Data Block Address N 315. Column 320 contains Logical Block Offset 0 321, Logical Block Offset 1 322, Logical Block Offset 2 323, Logical Block Offset 3 324, and Logical Block Offset N 325. Column 330 contains Extent Count 0 331, Extent Count 1 332, Extent Count 2 333, Extent Count 3 334, and Extent Count N 335. Column 340 contains Sub-zone Logical Block Address 0 341, Sub-zone Logical Block Address 1 342, Sub-zone Logical Block Address 2 343, Sub-zone Logical Block Address 3 344, and Sub-zone Logical Block Address N 345.

The extent description size changes as storage media size increases, possibly leading to changes in eBlock or zone size to minimize extent description size. An environment that only writes in eBlock sizes on eBlock sized LBA address boundaries only needs one extent description (6 bytes) per eBlock. There are 8,388,608 (2⁴⁰/2¹⁷=2²³) 128 KB eBlocks on a 1 TiB storage device, requiring 50,331,648 (2²³* 6 bytes=48 MiB) of translation memory. This is 0.586% (48 MiB/8 GiB) of the translation memory needed for the direct map implementation.

The remaining translation memory can be used to support eBlocks not written at eBlock logical block address boundaries or write commands smaller than eBlock size. 8 GiB of translation memory can hold 1,431,655,765 (2³³/6) extent descriptions. Each extent description can describe as little as one logical block if necessary, so the extent descriptions can describe 66% (1,431,655,765/2,147,483,648) of the storage device written in a purely random traffic pattern environment.

If the storage device is not in a mostly sequential traffic pattern environment and available extent descriptors become rare, zones with an extent description count greater than the minimum needed for the purely sequential traffic pattern (4 MiB (2²²) zone size/128 KB (2¹⁷) eBlock size=32 eBlocks per zone) can be re-written sequentially to new data block locations, re-sequencing the data and increasing the available extent description count at the cost of write amplification.

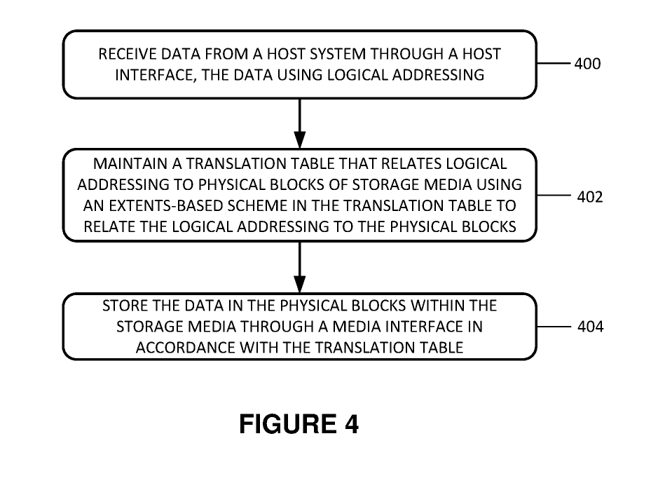

FIG. 4 illustrates an exemplary method for operating a storage controller 130. In this example, the storage controller 130 receives data from host system 110 through host interface 121, (operation 400). The data uses logical addressing.

Processing system 122 maintains translation table 124 that relates logical addressing to physical blocks of one or more storage media 150 using at least an extents-based scheme in the translation table 124 to relate the logical addressing to the physical blocks, (operation 402). The extents-based scheme comprises a starting location combined with span length of a sequential portion of data stored on the one or more storage media.

Storage controller 130 stores the data in the physical blocks within storage media 150 through media interface 125 in accordance with translation table 124, (operation 404).

FIG. 5 illustrates an example storage controller 500, such as storage controller 130 from FIG. 1. As discussed above, storage controller 500 may take on any of a wide variety of configurations. Here, an example configuration is provided for a storage controller implemented as an ASIC, a FPGA, or the like. However, in other examples, storage controller 500 may be built into a storage system or storage array, or into a host system.

In this example embodiment, storage controller 500 comprises host interface 510, processing circuitry 520, media interface 530, and internal storage system 540. Host interface 510 comprises circuitry configured to receive data and commands from external host systems and to send data to the host systems. Media interface 530 comprises circuitry configured to send data and commands to storage media and to receive data from the storage media.

Processing circuitry 520 comprises electronic circuitry configured to perform the tasks of a storage controller as described above. Processing circuitry 520 may comprise microprocessors and other circuitry that retrieves and executes software 560. Processing circuitry 520 may be embedded in a storage system in some embodiments. Examples of processing circuitry 520 include general purpose central processing units, application specific processors, and logic devices, as well as any other type of processing device, combinations, or variations thereof. Processing circuitry 520 can be implemented within a single processing device but can also be distributed across multiple processing devices or sub-systems that cooperate in executing program instructions.

Internal storage system 540 can comprise any non-transitory computer readable storage media capable of storing software 560 that is executable by processing circuitry 520. Internal storage system 540 can also include various data structures 550 which comprise one or more databases, tables, lists, or other data structures. In this example, data 550 includes translation memory 552 where one or more translation tables 554 are stored. Internal storage system 540 can include volatile and nonvolatile, removable and non-removable media implemented in any method or technology for storage of information, such as computer readable instructions, data structures, program modules, or other data.

Internal storage system 540 can be implemented as a single storage device but can also be implemented across multiple storage devices or sub-systems co-located or distributed relative to each other. Internal storage system 540 can comprise additional elements, such as a controller, capable of communicating with processing circuitry 520. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof.

Software 560 can be implemented in program instructions and among other functions can, when executed by storage controller 500 in general or processing circuitry 520 in particular, direct storage controller 500, or processing circuitry 520, to operate as described herein for a storage controller. Software 560 can include additional processes, programs, or components, such as operating system software, database software, or application software. Software 560 can also comprise firmware or some other form of machine-readable processing instructions executable by elements of processing circuitry 520.

In at least one implementation, the program instructions can include management processes module 562. Management processes module 562 includes instructions for performing data storage as described herein along with storage media maintenance and overhead processes.

In general, software 560 can, when loaded into processing circuitry 520 and executed, transform processing circuitry 520 overall from a general-purpose computing system into a special-purpose computing system customized to operate as described herein for a storage controller, among other operations. Encoding software 560 on internal storage system 540 can transform the physical structure of internal storage system 540. The specific transformation of the physical structure can depend on various factors in different implementations of this description. Examples of such factors can include, but are not limited to, the technology used to implement the storage media of internal storage system 540 and whether the computer-storage media are characterized as primary or secondary storage.

For example, if the computer-storage media are implemented as semiconductor-based memory, software 560 can transform the physical state of the semiconductor memory when the program is encoded therein. For example, software 560 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above may be combined in various ways to form multiple embodiments. As a result, the invention is not limited to the specific embodiments described above, but only by the claims and their equivalents.

What is claimed is:

1. A storage controller for a storage system, comprising:
a host interface, configured to receive and transmit data using logical addressing;
a media interface, configured to store and retrieve data in physical blocks within one or more storage media; and
a processing system, coupled with the host interface and the media interface, configured to maintain a translation table that relates logical addressing to physical blocks of the one or more storage media using at least an extents-based scheme in the translation table to relate the logical addressing to the physical blocks, wherein the extents-based scheme comprises a starting location combined with span length of a sequential portion of data stored on the one or more storage media, and the processing system also configured to handle storage operations of the storage drive in accordance with the translation table.

2. The storage controller of claim 1, wherein the translation table includes data block addresses, logical block offsets, and extent counts.

3. The storage controller of claim 2, wherein the translation table also includes sub-zone logical block addresses.

4. The storage controller of claim 1, wherein a first portion of the storage media is zoned for a sequential traffic pattern, and a second portion of the storage media is zoned for a random traffic pattern.

5. The storage controller of claim 4, wherein a first portion of the translation table uses an extents-based scheme for the first portion of the storage media, and a second portion of the translation table uses direct mapping between logical addresses and physical blocks of the storage media for the second portion of the storage media.

6. The storage controller of claim 4, wherein the processing system is further configured to:
upon detection of a triggering event, configure the second portion of the storage media for a sequential traffic model, and convert the second portion of the translation table into an extents-based scheme.

7. The storage controller of claim 6, wherein the triggering event is a size of the second portion of the translation table.

8. A method of operating a storage controller comprising:
receiving data from a host system through a host interface, the data using logical addressing;
maintaining a translation table that relates logical addressing to physical blocks of one or more storage media using at least an extents-based scheme in the translation table to relate the logical addressing to the physical blocks, wherein the extents-based scheme comprises a starting location combined with span length of a sequential portion of data stored on the one or more storage media; and
storing the data in the physical blocks within the storage media through a media interface in accordance with the translation table.

9. The method of claim 8, wherein the translation table includes data block addresses, logical block offsets, and extent counts.

10. The method of claim 9, wherein the translation table also includes sub-zone logical block addresses.

11. The method of claim 8, wherein a first portion of the storage media is zoned for a sequential traffic pattern, and a second portion of the storage media is zoned for a random traffic pattern.

12. The method of claim 11, wherein a first portion of the translation table uses an extents-based scheme for the first portion of the storage media, and a second portion of the translation table uses direct mapping between logical addresses and physical blocks of the storage media for the second portion of the storage media.

13. The method of claim 4, further comprising:
upon detection of a triggering event, configuring the second portion of the storage media for a sequential traffic model, and converting the second portion of the translation table into an extents-based scheme.

14. The method of claim 13, wherein the triggering event is a size of the second portion of the translation table.

15. A storage drive, comprising:
a processing system configured to maintain a translation table that relates logical addressing to physical blocks of one or more storage media using at least an extents-based scheme in the translation table to relate the logical addressing to the physical blocks, wherein the extents-based scheme comprises a starting location combined with span length of a sequential portion of data stored on the one or more storage media; and
the processing system configured to handle storage operations of the storage drive in accordance with the translation table.

16. The storage drive of claim 15, wherein the translation table includes data block addresses, logical block offsets, and extent counts.

17. The storage drive of claim 16, wherein the translation table also includes sub-zone logical block addresses.

18. The storage drive of claim 15, wherein a first portion of the storage media is zoned for a sequential traffic pattern, and a second portion of the storage media is zoned for a random traffic pattern.

19. The storage drive of claim 18, wherein a first portion of the translation table uses an extents-based scheme for the first portion of the storage media, and a second portion of the translation table uses direct mapping between logical addresses and physical blocks of the storage media for the second portion of the storage media.

20. The storage drive of claim 18, wherein the processing system is further configured to:
upon detection of a triggering event, configure the second portion of the storage media for a sequential traffic model, and convert the second portion of the translation table into an extents-based scheme.
